(19) United States
(12) Patent Application Publication
(10) Pub. No.: US 2025/0320753 A1
(43) Pub. Date: Oct. 16, 2025

(54) Climbing Safety Harness Storage Arrangement

(71) Applicant: Donald Coleman, Pearland, TX (US)

(72) Inventor: Donald Coleman, Pearland, TX (US)

(21) Appl. No.: 18/633,221

(22) Filed: Apr. 11, 2024

(51) Int. Cl. E05B 65/00; E05B 19/00

(52) U.S. Cl. CPC E05B 65/0075; E05B 19/0005

(57) ABSTRACT

A climbing safety harness storage arrangement includes a storage container, a door, a locking mechanism, a sealing structure, a hanging structure, and a mounting member. The storage container can be placed adjacent a climbing structure, such as a ladder or scaffolding, in a work environment in which wearing of climbing safety harnesses for climbing is mandated by government regulation. The sealing structure seals the storage container when the door is closed to minimize or prevent entry of water or insects into the storage container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to storage containers and more particularly pertains to a new climbing safety harness storage arrangement for providing workers with quick and easy access to climbing safety harnesses where their use is required by law. The climbing safety harness storage arrangement can be detachably connected to a supporting structure, such as steel framework, walls, and pipes, that is adjacent a climbing structure, such as a ladder or scaffolding, in a work environment, such as an industrial, construction, or commercial setting, in which wearing of climbing safety harnesses for climbing is mandated by government regulation, such as those set by the Occupational Safety and Health Administration (OSHA).

### (2) Description of Related Art Including Information Disclosed Under 37 CFR 1.97 and 1.98

The prior art relates to storage containers. The prior art, as best understood, does not disclose a climbing safety harness storage arrangement that includes a storage container, a door, a locking mechanism, a sealing structure, a hanging structure, and a mounting member, wherein the storage container can be placed adjacent a climbing structure, such as a ladder or scaffolding, in a work environment in which wearing of climbing safety harnesses for climbing is mandated by government regulation.

### BRIEF SUMMARY OF THE INVENTION

An embodiment of the disclosure meets the needs presented above in a climbing safety harness storage arrangement generally comprising a storage container, a door, a locking mechanism, a sealing structure, a hanging structure, and a mounting member. The storage container includes a top wall, a bottom wall, a back wall, a left side wall, and a right side wall. The storage container has an open end and is designed to receive and house at least one climbing safety harness therein. The door is pivotably attached to the left side wall and includes a handle. The door is designed to cover the open end of the storage container to close the storage container. The locking mechanism is designed to securely lock the door shut. The sealing structure is designed and positioned to seal between the door and the open end of the storage container when the door is closed to minimize or prevent entry of water or insects into the storage container. The hanging structure is positioned inside the storage container and designed to support a climbing safety harness in a suspended manner inside the storage container. The mounting member is designed to be connected to the back wall to permit detachable mounting of the storage container on a supporting structure adjacent a climbing structure in a work environment in which wearing of climbing safety harnesses for climbing is mandated by government regulation.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a climbing safety harness storage arrangement according to an embodiment of the disclosure.

FIG. 2 is a front perspective view of an embodiment of the disclosure.

FIG. 3 is a close-up view of a portion of an embodiment of the disclosure.

FIG. 4 is an open perspective view of an embodiment of the disclosure.

FIG. 5 is a rear view of an embodiment of the disclosure.

FIG. 6 is a view of a portion of an embodiment of the disclosure.

FIG. 7 is a side view of an embodiment of the disclosure in use.

FIG. 8 is an open front view of an embodiment of the disclosure in use.

FIG. 9 is a rear perspective view of an embodiment of the disclosure.

### DETAILED DESCRIPTION OF THE INVENTION

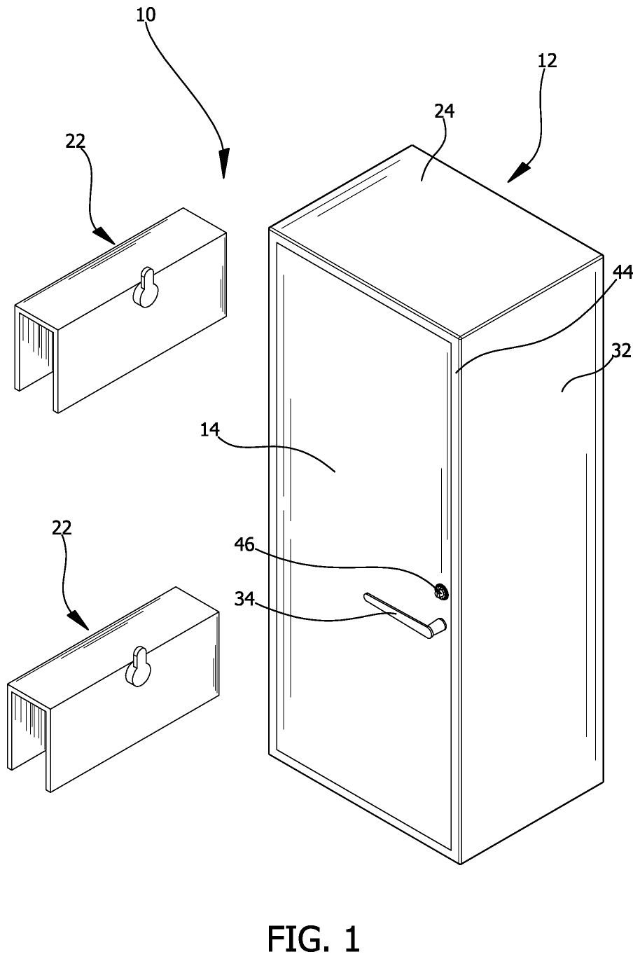

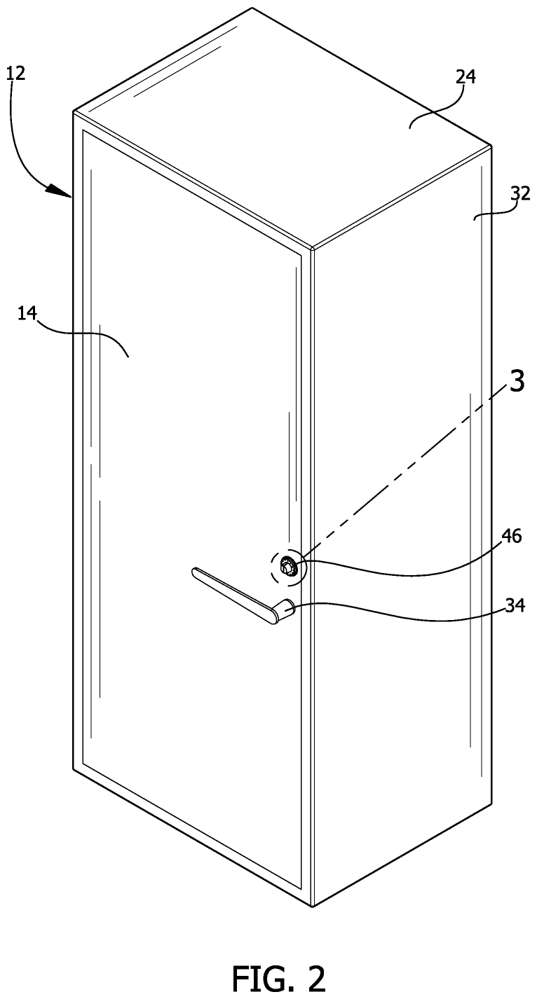

With reference now to the drawings, and in particular to FIGS. 1 through 9 thereof, a new climbing safety harness storage arrangement embodying the principles and concepts of an embodiment of the disclosure and generally designated by the reference numeral 10 will be described.

As best illustrated in FIGS. 1 through 9, the climbing safety harness storage arrangement 10 generally comprises a storage container 12, a door 14, a locking mechanism 16, a sealing structure 18, a hanging structure 20, and a mounting member 22. The storage container 12 includes a top wall 24, a bottom wall 26, a back wall 28, a left side wall 30, and a right side wall 32. The storage container 12 has an open end 36 and is designed to receive and house at least one climbing safety harness 70 therein. For example, the storage container 12 could have a width of about 18 inches and a length of about 24 inches, which are suitable sizes for the climbing safety harness 70. The door 14 is pivotably attached to the left side wall 30 and includes a handle 34. The door 14 is designed to cover the open end 36 of the storage container 12 to close the storage container 12.

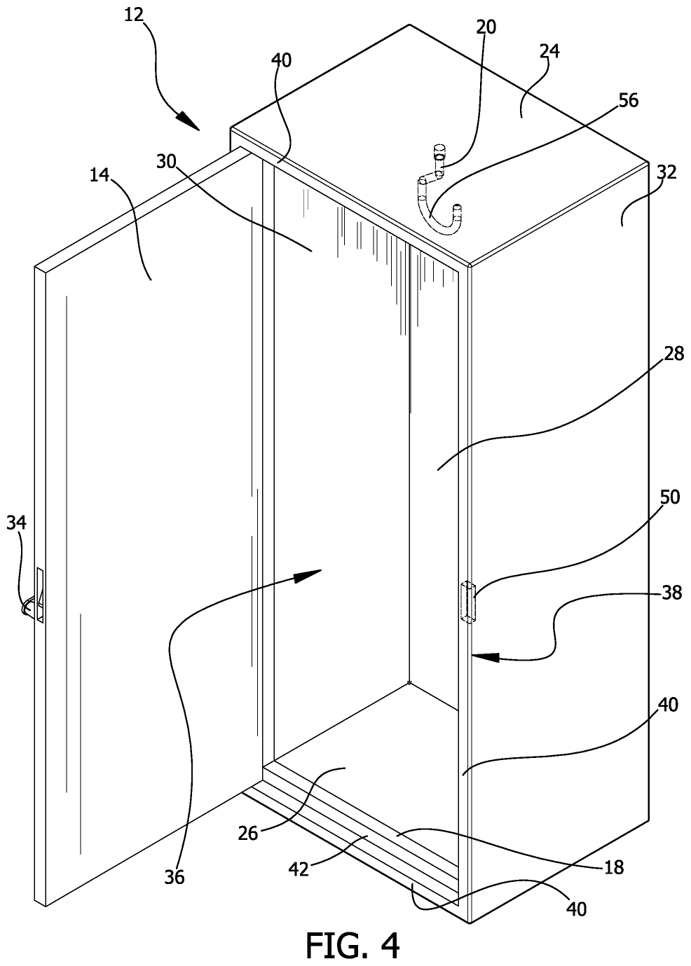

With reference to FIG. 4, each of the top wall 24, the bottom wall 26, the left side wall 30, and the right side wall 32 includes a front end portion 38 positioned at the open end 36 of the storage container 12. Each of the front end portions 38 includes an end surface 40 and an interior shoulder portion 42. The interior shoulder portions 42 together define a door frame 44 designed such that the door 14 is positioned within the door frame 44 and flush with the end surfaces 40 when the door 14 is closed, as shown in FIG. 1.

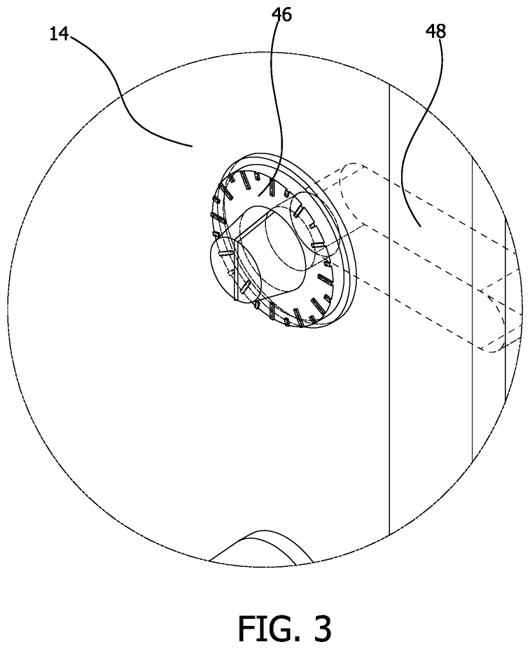

The locking mechanism 16 is designed to securely lock the door 14 shut. The locking mechanism 16 includes a security device 46 and a blocking structure 48. The right side wall 32 includes a recess 50 designed to receive the blocking structure 48. The security device 46 is designed to be actuated to move the blocking structure 48 into engagement with the recess 50 to lock the door 14 in a closed position. The security device 46 includes a combination lock or a key lock or a keypad lock. Essentially any door-locking mechanism 16 is within the scope of the disclosure. FIG. 3 shows a possible embodiment in which the security device 46 is a combination lock and the blocking structure 48 is a slidable bolt.

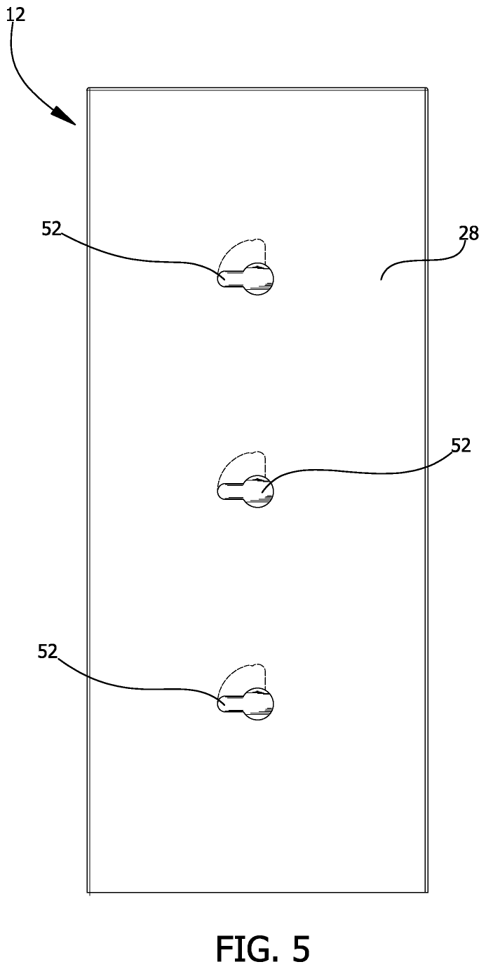

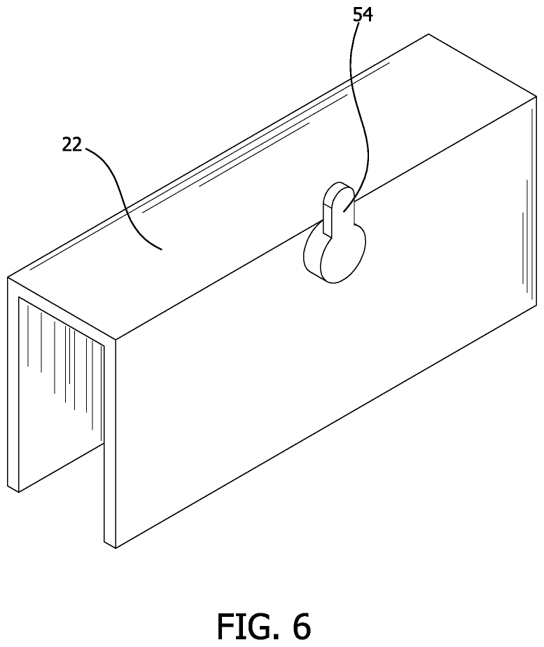

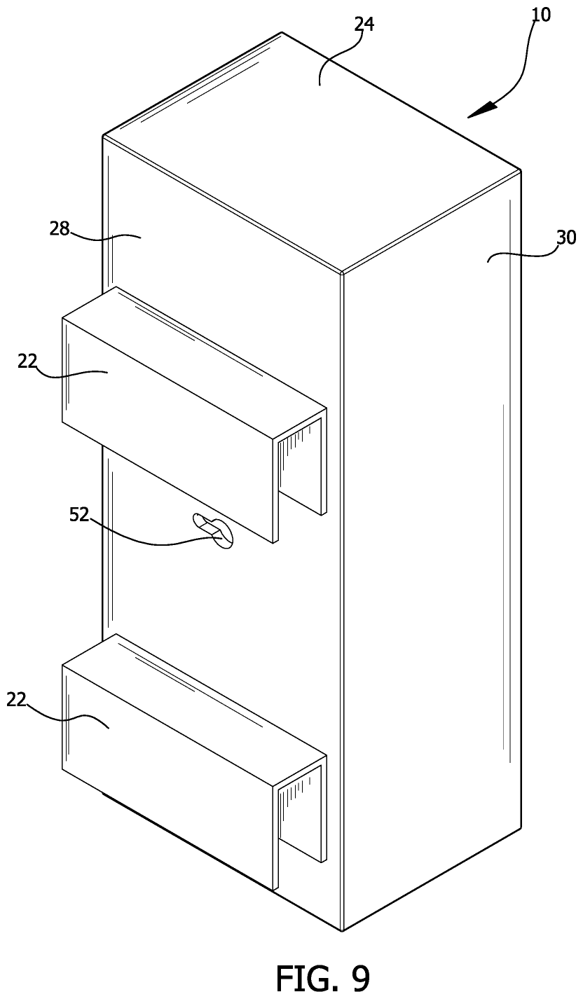

The mounting member 22 is designed to be connected to the back wall 28 to permit detachable mounting of the storage container 12 on a supporting structure 72 adjacent a climbing structure 74 in a work environment in which wearing of climbing safety harnesses 70 for climbing is mandated by government regulation. The back wall 28 includes mounting receptacles 52. The mounting member 22 includes a mounting projection 54 designed to be inserted into one of the mounting receptacles 52 to detachably connect the mounting member 22 to the back wall 28. In the embodiment shown in FIG. 5, the mounting receptacles 52 are designed such that the mounting projections 54 are inserted and then rotated 90 degrees to lock the mounting projections 54 in place. However, any suitable detachable connection, such as screws, bolts, or snap-fit connectors, is within the scope of the disclosure The mounting member 22, as shown in FIG. 6, can be in the form of a bracket designed to be placed or slid onto a supporting structure 72 to hang the storage container 12 in a suspended manner. The bracket shape allows for quick and easy installation and removal on pipes, steel framework, or similar structures. As shown in FIGS. 1 and 9, more than one mounting member 22 may be used to permit additional support and stability in detachably mounting the storage container 12.

As shown in FIG. 5, the mounting receptacles 52 are positioned spaced apart at different heights along the back wall 28 to permit attachment of the mounting member 22 at different positions on the back wall 28, such as is shown in FIG. 9. The storage container 12 is portable to permit a user to move the storage container 12 from one location to another location where climbing is to be performed.

The storage container 12 is designed to be durable and weather-resistant for use in outdoor environments. Each of the top wall 24, the bottom wall 26, the back wall 28, the left side wall 30, and the right side wall 32 includes ultraviolet-resistant and weather-resistant material. In addition, the door 14 includes ultraviolet-resistant and weather-resistant material. To protect the climbing safety harnesses 70 inside the storage container 12, the sealing structure 18 is designed and positioned to seal between the door 14 and the open end 36 of the storage container 12 when the door 14 is closed to minimize or prevent entry of water or insects into the storage container 12. The sealing structure 18 can be a rubber or elastomer gasket that is positioned on outer perimeter surfaces of the door 14 or on the interior shoulder portions 42.

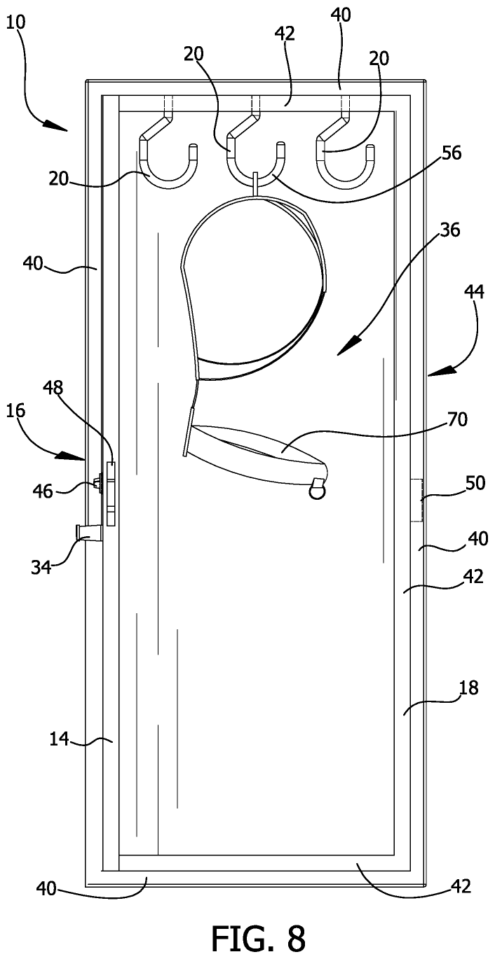

The hanging structure 20 is positioned inside the storage container 12 and designed to support the climbing safety harness 70 in a suspended manner inside the storage container 12. In the embodiment shown in FIG. 4, the hanging structure 20 includes a hook 56 attached to the top wall 24, though other hanging structures such as clips could be used. In addition, only one hook 56 is shown. In the embodiment shown in FIG. 8, multiple hanging structures 20 can be included to permit storage of multiple climbing safety harnesses 70 in an organized manner, though one hanging structure 20 could be sufficient as shown in FIG. 4.

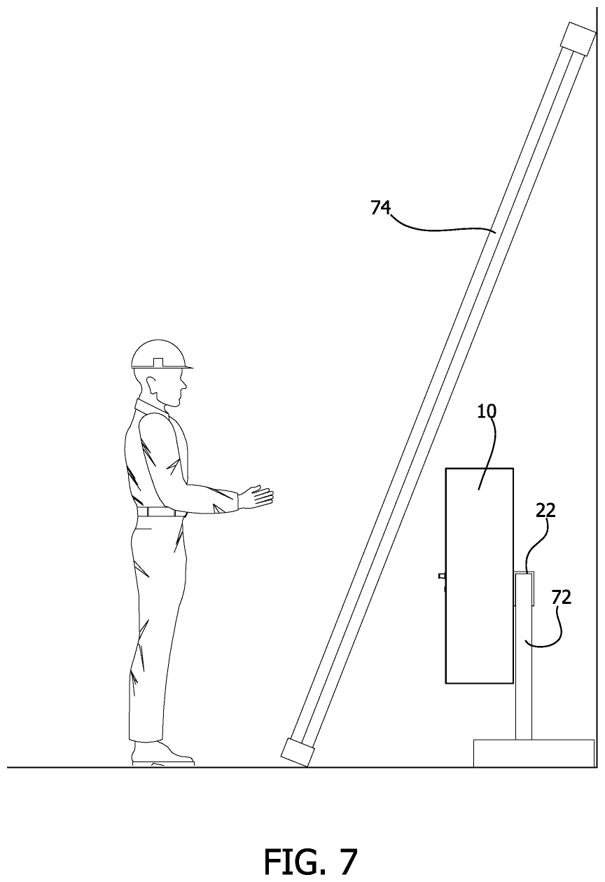

With reference to FIG. 7, in order to use the climbing safety harness storage arrangement 10, a user can connect the mounting member 22 to the back wall 28 of the storage container 12. The user then detachably mounts the mounting member 22 and the storage container 12 on a supporting structure 72 adjacent a climbing structure 74 in a work environment in which wearing of climbing safety harnesses 70 for climbing is mandated by government regulation. In the example shown in FIG. 7, the supporting structure 72 is a railing or stanchion adjacent a climbing structure 74, which in this case is a ladder. The user can use the climbing safety harness 70 in a climbing activity and then store the climbing safety harness 70 in the storage container 12. The user can then have the climbing safety harness 70 on site the next time the user engages in a climbing activity. Since the climbing safety harness storage arrangement 10 is freely suspended on the supporting structure 72, the user can easily transport the climbing safety harness storage arrangement 10 for use at other locations.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A climbing safety harness storage arrangement comprising:
a storage container comprising a top wall, a bottom wall, a back wall, a left side wall, and a right side wall;
said storage container having an open end and being configured to receive and house at least one climbing safety harness therein;
a door pivotably being attached to said left side wall and comprising a handle;
said door being configured to cover said open end of said storage container to close said storage container;
a locking mechanism being configured to securely lock said door shut;
a sealing structure being configured and disposed to seal between said door and said open end of said storage container upon said door being closed to minimize or prevent entry of water or insects into said storage container;
a hanging structure being disposed inside said storage container and configured to support a climbing safety harness in a suspended manner inside said storage container; and
a mounting member being configured to be connected to said back wall to permit detachable mounting of said storage container on a supporting structure adjacent a climbing structure in a work environment in which wearing of climbing safety harnesses for climbing is mandated by government regulation.

2. The climbing safety harness storage arrangement of claim 1, wherein:
each of said top wall, said bottom wall, said left side wall, and said right side wall comprises a front end portion disposed at said open end of said storage container;
each of said front end portions comprises an end surface and an interior shoulder portion;
said interior shoulder portions together define a door frame configured such that said door is disposed within said door frame and flush with said end surfaces upon said door being closed; and
said sealing structure is disposed on said interior shoulder portions.

3. The climbing safety harness storage arrangement of claim 1, wherein:
wherein said locking mechanism comprises a security device and a blocking structure;
said security device is configured to be actuated to move said blocking structure into engagement with said recess to lock said door in a closed position; and
said right side wall comprises a recess configured to receive said blocking structure.

4. The climbing safety harness storage arrangement of claim 3, wherein said security device comprises a combination lock or a key lock or a keypad lock.

5. The climbing safety harness storage arrangement of claim 1, wherein:
said back wall comprises mounting receptacles; and
said mounting member comprises a mounting projection configured to be inserted into one of said mounting receptacles to detachably connect said mounting member to said back wall.

6. The climbing safety harness storage arrangement of claim 5, wherein said mounting receptacles are positioned spaced apart at different heights along said back wall to permit attachment of said mounting member at different positions on said back wall.

7. The climbing safety harness storage arrangement of claim 1, wherein said mounting member comprises a bracket configured to be placed or slid onto a supporting structure to hang said storage container in a suspended manner.

8. The climbing safety harness storage arrangement of claim 1, further comprising at least one additional mounting member to permit additional support and stability in detachably mounting said storage container.

9. The climbing safety harness storage arrangement of claim 1, wherein said sealing structure is disposed on outer perimeter surfaces of said door.

10. The climbing safety harness storage arrangement of claim 1, wherein said sealing structure comprises a rubber or elastomer gasket.

11. The climbing safety harness storage arrangement of claim 1, wherein said hanging structure comprises a hook attached to said top wall.

12. The climbing safety harness storage arrangement of claim 1, further comprising at least one additional hanging structure to permit storage of multiple climbing safety harnesses in an organized manner.

13. The climbing safety harness storage arrangement of claim 1, wherein each of said hanging structure and said at least one additional hanging structure comprises a hook attached to said top wall, which hooks are spaced apart.

14. The climbing safety harness storage arrangement of claim 1, wherein said storage container is portable to permit a user to move said storage container from one location to another location where climbing is to be performed.

15. The climbing safety harness storage arrangement of claim 1, wherein each of said top wall, said bottom wall, said back wall, said left side wall, and said right side wall comprises ultraviolet-resistant and weather-resistant material.

16. The climbing safety harness storage arrangement of claim 15, wherein said door comprises ultraviolet-resistant and weather-resistant material.

17. A method of storing climbing safety harnesses using a climbing safety harness storage arrangement of claim 1, said method comprising the steps of:
connecting said mounting member to said back wall of said storage container;
detachably mounting said mounting member and said storage container on a supporting structure adjacent a climbing structure in a work environment in which wearing of climbing safety harnesses for climbing is mandated by government regulation;
using a climbing safety harness in a climbing activity;
opening said door, placing said safety harness on said hanging structure in said storage container, and closing said door;
opening said door, retrieving said safety harness, and closing said door; and
using said climbing safety harness in another climbing activity.

18. The method of claim 17, further comprising the step of detaching said mounting member and said storage container from said supporting structure and transporting said climbing safety harness storage arrangement to another supporting structure adjacent a climbing structure in another work environment in which wearing of climbing safety harnesses for climbing is mandated by government regulation.

19. The method of claim 17, further comprising storing multiple climbing safety harnesses on multiple hanging structures for multiple users.

20. A climbing safety harness storage arrangement comprising:
a storage container comprising a top wall, a bottom wall, a back wall, a left side wall, and a right side wall; said storage container having an open end and being configured to receive and house at least one climbing safety harness therein; each of said top wall, said bottom wall, said left side wall, and said right side wall comprises a front end portion disposed at said open end of said storage container; each of said front end portions comprises an end surface and an interior shoulder portion; said interior shoulder portions together define a door frame configured such that said door is disposed within said door frame and flush with said end surfaces upon said door being closed; said right side wall comprises a recess configured to receive said blocking structure; said back wall comprises mounting receptacles; said mounting receptacles are positioned spaced apart at different heights along said back wall to permit attachment of said mounting member at different positions on said back wall; said storage container is portable to permit a user to move said storage container from one location to another location where climbing is to be performed; each of said top wall, said bottom wall, said back wall, said left side wall, and said right side wall comprises ultraviolet-resistant and weather-resistant material;
a door pivotably attached to said left side wall and comprising a handle; said door being configured to cover said open end of said storage container to close said storage container; said door comprises ultraviolet-resistant and weather-resistant material;
a locking mechanism configured to securely lock said door shut; wherein said locking mechanism comprises a security device and a blocking structure; said security device is configured to be actuated to move said blocking structure into engagement with said recess to lock said door in a closed position; said security device comprises a combination lock or a key lock or a keypad lock;
a sealing structure configured and disposed to seal between said door and said open end of said storage container upon said door being closed to minimize or prevent entry of water or insects into said storage container; one of (A) and (B): (A) said sealing structure is disposed on outer perimeter surfaces of said door, and (B) said sealing structure is disposed on said interior shoulder portions; said sealing structure comprises a rubber or elastomer gasket;
a hanging structure disposed inside said storage container and configured to support a climbing safety harness in a suspended manner inside said storage container; said hanging structure comprises a hook attached to said top wall;
at least one additional hanging structure to permit storage of multiple climbing safety harnesses in an organized manner;
a mounting member being configured to be connected to said back wall to permit detachable mounting of said storage container on a supporting structure adjacent a climbing structure in a work environment in which wearing of climbing safety harnesses for climbing is mandated by government regulation; said mounting member comprises a mounting projection configured to be inserted into one of said mounting receptacles to detachably connect said mounting member to said back wall; said mounting member comprises a bracket configured to be placed or slid onto a supporting structure to hang said storage container in a suspended manner; and
at least one additional mounting member to permit additional support and stability in detachably mounting said storage container.
